(19) United States
(12) Patent Application Publication
(10) Pub. No.: US 2016/0205398 A1
(43) Pub. Date: Jul. 14, 2016

(54) APPARATUSES AND METHODS FOR EFFICIENT RANDOM NOISE ENCODING

(71) Applicant: MAGNUM SEMICONDUCTOR, INC., MILPITAS, CA (US)

(72) Inventor: PAVEL NOVOTNY, WATERLOO (CA)

(21) Appl. No.: 14/592,539

(22) Filed: Jan. 8, 2015

(51) Int. Cl. H04N 19/103; H04N 19/51; H04N 19/85; H04N 19/154; H04N 19/159

(52) U.S. Cl. CPC H04N 19/103; H04N 19/154; H04N 19/159; H04N 19/85; H04N 19/51

(57) ABSTRACT

Apparatuses and methods are disclosed herein that describe efficient encoding of random noise. For example, a method for efficiently encoding random noise is described that includes intra-coding a frame that includes noise and copying the noise from the intra-coded frame into a subsequent frame during encoding using motion estimation. An example apparatus for efficient encoding of random noise may include an encoder configured to copy noise from an encoded reference intra-coded frame into an inter-coded frame based on a best mode decision, wherein the inter-coded frame at least partially comprises noise, and a mode decision block configured to determine the best mode for encoding the inter-coded frame.

### TECHNICAL FIELD

Embodiments of this invention relate generally to video encoding, and examples of systems and methods for encoding random noise efficiently.

### BACKGROUND

Video or other media signals may be used by a variety of devices, including televisions, broadcast systems, mobile devices, and both laptop and desktop computers. Typically, devices may display video in response to receipt of video or other media signals, often after decoding the signal from an encoded form. Video signals provided between devices are often encoded using one or more of a variety of encoding and/or compression techniques, and video signals are typically encoded in a manner to be decoded in accordance with a particular standard, such as MPEG-2, MPEG-4, and H.264/MPEG-4 Part 10. By encoding video or other media signals, then decoding the received signals, the amount of data provided between devices may be significantly reduced.

Video encoding typically proceeds by sequentially encoding macroblocks, or other coding units, of video data. Prediction coding may be used to generate predictive blocks and residual blocks, where the residual blocks represent a difference between a predictive block and the block being coded. Prediction coding may include spatial and/or temporal predictions to remove redundant data in video signals, thereby further improving data compression. Intra-coding for example, is directed to spatial prediction and reducing the amount of spatial redundancy between blocks in a frame or a slice. Inter-coding, on the other hand, is directed toward temporal prediction and reducing the amount of temporal redundancy between blocks in successive frames or slices. Inter-coding may make use of motion prediction to track movement between corresponding blocks of successive frames or slices.

Typically, images and video to be encoded include various amounts of noise, such as random noise. This random noise, in many situations, would likely be filtered from the images and the video before encoding to clean up the image and to minimize the cost of the encoding steps (e.g., the number of bits used to encode the video at a certain quality level). Other times, however, random noise, which may be due to film grain or intentionally introduced artifacts, may be desired and maintenance of the random noise preferred. Thus, in this scenario, the random noise would likely need to be encoded along with the other features (e.g., texture and edges) of the video for transmission.

Many current approaches to encoding random noise may use the intra-coding technique, which is costly. The intra-coding is costly because the random noise is not predictable (e.g., it is random) and further because the encoding may be done within each macroblock or frame instead of between two adjacent frames. This results in a higher percentage of the frame or macroblock being encoded and the predictive ability of the encoder utilized less, if at all. Therefore, an efficient means to encode random noise using inter-coding may be desired.

### BRIEF DESCRIPTION OF THE DRAWINGS

FIG. 1 is a block diagram of an encoder according to an embodiment of the present invention.

FIG. 2 is a block diagram of an encoder according to an embodiment of the present invention.

FIG. 3 is a flowchart of a method for copying random noise into an encoded frame according to an embodiment of the present invention.

FIG. 4 is a mode decision block according to an embodiment of the present invention.

FIG. 5 is a flowchart of a method for adjusting a mode decision process for efficiently encoding random noise according to an embodiment of the present invention.

FIG. 6 is a schematic illustration of a media delivery system according to an embodiment of the invention.

FIG. 7 is a schematic illustration of a video distribution system that may make use of encoders described herein.

### DETAILED DESCRIPTION

Examples of apparatuses and methods for efficiently encoding random noise are described herein. In accordance with one or more described embodiments, an encoder may introduce (e.g., copy) noise from a reference frame into subsequently encoded inter-predicted frames that also include random noise. In some examples the level of random noise in the subsequently encoded frames may be at high levels and may only include random noise. This approach may preserve the look of the original random noise included in the subsequent frames without requiring the encoder to encode the noise exactly for each inter-predicted frame. Additionally or alternatively, an encoder may filter (e.g., low pass filter) the random noise, which may preserve the precision of the low frequency components over the high frequency components of the random noise while preserving the visual quality of the random noise. Certain details are set forth below to provide a sufficient understanding of embodiments of the invention. However, it will be clear to one having skill in the art that embodiments of the invention may be practiced without these particular details, or with additional or different details. Moreover, the particular embodiments of the present invention described herein are provided by way of example and should not be used to limit the scope of the invention to these particular embodiments. In other instances, well-known video components, encoder or decoder components, circuits, control signals, timing protocols, and software operations have not been shown in detail in order to avoid unnecessarily obscuring the invention.

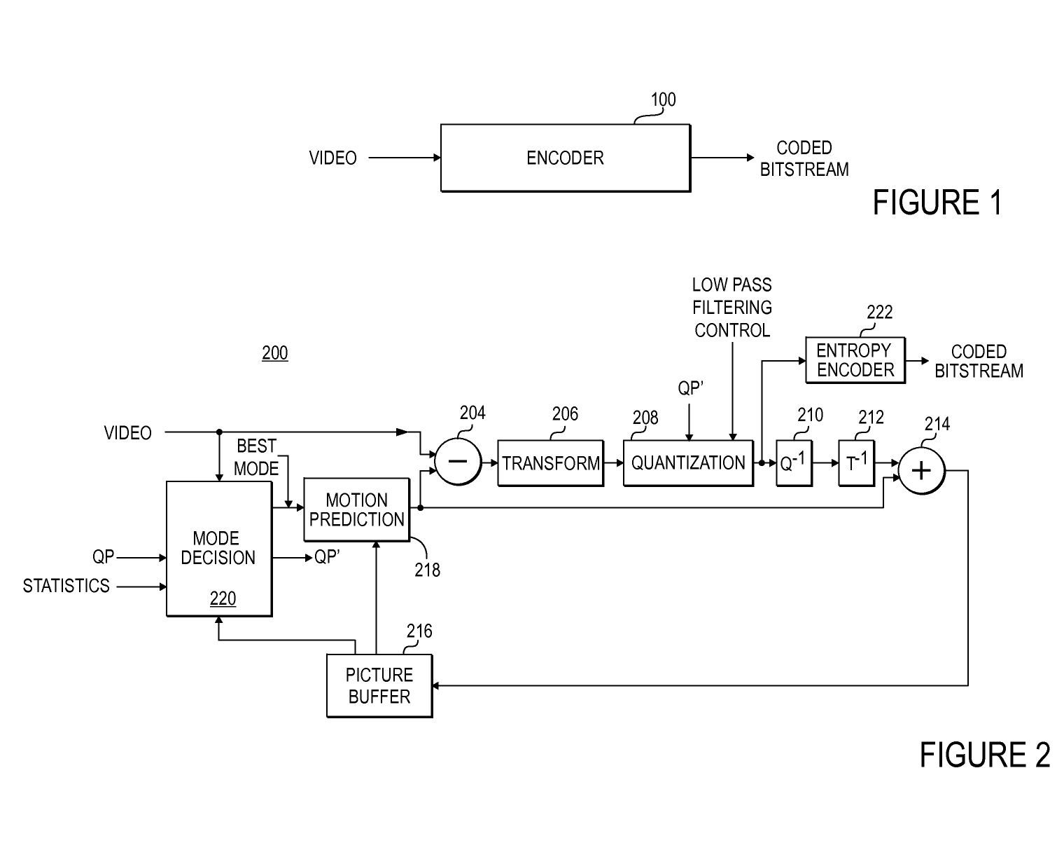

FIG. 1 is a block diagram of an apparatus in the form of an encoder 100 according to an embodiment of the invention. The encoder 100 may include one or more logic circuits, control logic, logic gates, processors, pre-processors, memory, and/or any combination or sub-combination of the same, and may be configured to encode and/or compress a video signal using one or more encoding techniques, examples of which will be described further below. The encoder 100 may be configured to encode, for example, a variable bit rate signal and/or a constant bit rate signal, and generally may operate at a fixed rate to output a bitstream that may be generated in a rate-independent manner. The encoder 100 may be implemented in any of a variety of devices employing video encoding, including, but not limited to, televisions, broadcast systems, mobile devices, and both laptop and desktop computers.

In at least one embodiment, the encoder 100 may include an entropy encoder, such as a variable-length coding encoder (e.g., Huffman encoder or CAVLC encoder), and/or may be configured to encode data, for instance, at a block level, where a block may be a macroblock or a sub-macroblock. Macroblock may predominantly be used herein, but its use is intended to include all block sizes. Each macroblock may be encoded in intra-coded mode, inter-coded mode, bidirectionally, or in any combination or subcombination of the same.

By way of example, the encoder 100 may receive and encode a video signal that includes a plurality of sequentially ordered coding units (e.g., blocks, macroblocks, slices, frames, fields, groups of pictures, sequences, etc.). Each coding unit may be comprised of a plurality of smaller coding units. For example, a frame of the video signal may be comprised of a plurality of macroblocks. The video signal may be encoded in accordance with one or more encoding standards, such as MPEG-2, MPEG-4, H.263, H.264, H.265, and/or HEVC, to provide a coded bitstream. The coded bitstream may in turn be provided to a data bus and/or to a device, such as a decoder or transcoder (not shown in FIG. 1). A video signal may include a transient signal, stored data, or both.

To encode each macroblock of a video signal, the encoder may utilize a standard mode decision process or a noise optimized mode decision process to determine the best mode to use for encoding each macroblock of a frame. By way of example, for macroblocks that include relatively high levels of random noise, the encoder 100 may use the noise optimized mode decision process for determining the best mode to use for efficiently encoding these macroblocks in a manner that preserves the random noise. Macroblocks that do not include relatively high levels of random noise or macroblocks that have been filtered of random noise may be encoded using any of the standard modes available to the encoder 100 as determined by the standard mode decision process. In some examples, the encoder 100 may determine noise levels using statistical analysis. Statistical analysis may be employed at the frame level, macroblock level, or any other coding unit level.

Due to the unpredictability of random noise, random noise may not be efficiently predicted, and as a result the predictive qualities of an encoder may not allow for efficient encoding of the random noise. As used herein, the term “efficient” may refer to a number of coding bits used to encode the coding unit, such as a frame or a macroblock. As a result, spatial encoding modes, which may also be referred to as intra coding unit encoding (intra-coding) modes, may be the conventional mode for encoding coding units that include high levels of random noise (or display only random noise) so that the random noise is preserved. Intra-coding, however, may be expensive in terms of coded bits, e.g., not very efficient, and good visual quality from a viewer's perspective may not be obtained for such macroblocks. Thus, a technique that encodes random noise without being costly in terms of coded bits, e.g., efficient, may be desired. One solution may involve copying random noise from an encoded reference frame (e.g., an i-frame) into subsequent non-reference frames (e.g., p-frames or b-frames) in a manner that maintains the properties of the original noise in the subsequent frames such that it looks “like” the original noise.

To this end, the encoder 100 may encode (e.g., periodically encode) random noise into the bitstream by intra-coding a frame of the input. This intra-coded frame may be subsequently used as a reference frame. Intra-coding modes may be used so that the random noise is directly encoded and the selected mode should use a sufficient number of bits such that the quality (e.g., amplitude and frequency spectrum) of the random noise is sufficiently captured in the reference frame. Subsequent frames of the input that also contain high levels of random noise may be encoded using inter-coding to take advantage of the predictive quality of the encoder 100 while preserving the nature and quality of the original random noise in the subsequent frame. The encoder 100 may select a “best” inter-coding mode for preserving the nature and quality of the random noise. The “best” mode, as used herein, may refer to the mode that copies noise from the reference frame in a manner and/or from an area of the reference frame that most closely resembles the random noise included in the current (e.g., the subsequent) frame.

In some examples, inter-coding may use motion compensation to copy the random noise from a reference frame, directly or indirectly, into an inter-coded frame, e.g., the current frame. The motion compensation uses random motion vectors, which may be the conventional case using standard motion estimation, as the motion estimation searches for the best match to the current frame in the reference frame. An inter-coding mode that does not alter the characteristics of the noise, the amplitude for instance, (e.g., the best mode) may be desired, and an inter-coding mode that provides such results may be selected by the encoder 100. If the amplitude of the random noise is reduced due to the selected encoding mode, the residual of the encoding stream may have to compensate for the reduction, which may be costly in terms of coded bits, e.g., reduced efficiency.

Additionally or alternatively, an encoder may low pass filter the random noise to preserve the low frequency components (the frequency components may also be referred to as coefficients) of the random noise, which tend to be more important to the visual quality and the visual presence of the random noise. By low pass filtering the random noise, the number of bits used to encode the low frequency components may be increased due to the high frequency components being filtered out with the low pass filter. The low pass filter technique may be implemented in combination with the solution that involves copying random noise from reference frames into a current frame.

FIG. 2 is a block diagram of an encoder 200 according to an embodiment of the present disclosure. The encoder 200 may be used to implement, at least in part, the encoder 100 of FIG. 1, and may further be compliant with one or more known coding standards, such as MPEG-2, H.264, and H.265 coding standards.

The encoder 200 may include a mode decision block 220, a motion prediction block 218, a subtractor 204, a transform 206, a quantization block 208, an entropy encoder 222, an inverse quantization block 210, an inverse transform block 212, an adder 214, and a picture buffer 216. The mode decision block 220 may receive an incoming video signal (e.g. a transient signal or stored data from a memory) and may determine an appropriate coding mode for the video signal based on properties of the video signal and a decoded picture buffer signal. The mode decision block may determine an appropriate coding mode on a per frame and/or macroblock basis. The mode decision may include macroblock type, intra modes, inter modes, syntax elements (e.g., motion vectors), and/or one or more quantization parameters. The mode decision block may further provide a mode decision for a temporal encoding mode that efficiently preserves random noise included in the frames and/or macroblocks of the input video when preservation of the random noise is desired. Further, the mode decision block 220 may progressively transition from a normal mode decision to a noise optimized mode decision to avoid potential switching artifacts.

The output of the mode decision block 220 may be utilized by the motion prediction block 218 to generate a predictor in accordance with one or more coding standards and/or other prediction methodologies. The predictor may be subtracted from the incoming video signal by the subtractor 204. The output of the subtractor 204 may be a residual, e.g. the difference between a block and a prediction for a block, which may then be encoded by the entropy encoder 222 after passing through the transform 206 and the quantization block 208. It may be desired by the encoder 200 to reduce a magnitude of the residual to the extent possible, since the residual is the data that is encoded and the size of the residual may affect the number of bits used for encoding, e.g., the efficiency of the encoder.

The mode decision block 220 may, based on the various inputs, determine an encoding mode for an input frame or macroblock that causes the encoder 200 to provide the best visual quality using the least amount of encoding bits. For frames and macroblocks that do not include high levels of random noise, for instance as indicated by an activity-variance parameter (referred to herein as “actvar”), the mode decision block 220 may evaluate all available modes, both temporal and spatial, to determine the best mode to select. The mode decision block may calculate a rate-distortion score (RD score) for each mode and choose the mode with the lowest RD score, which may be the best mode, for example. However, as noted, when a frame or block includes high levels of random noise, the mode decision block 220 may have a tendency to choose spatial encoding modes, which may be bit-wise costly and which may result in poor visual quality of the encoded random noise. To overcome such a deficiency, the mode decision block 220 may implement the noise optimized mode decision process, which copies noise from a reference frame to preserve the quality of the original noise in a non-reference frame.

The intra-coded frame may be periodically generated by an encoder as a reference for the decoder and other encoding processes. These frames may be encoded into the coded bit stream at a particular rate (e.g., once or twice a second) depending on the coding standard. The intra-coded frames may be conventionally encoded using intra-coding modes such that some or all aspects of the frame are encoded. The intra-coded frame may be considered a JPEG representation of that frame of video, for example. In encoding the intra-coded frame, the mode decision block 220 may evaluate all available spatial encoding modes and choose the best one as described above. Inter-coding modes may not be available for the intra-coded frame encoding. The intra-coded frame may then be used by the encoder 200 as a reference for subsequent inter-coded frames (e.g., p-frames and/or b-frames). The intra-coded frame may have areas that include high levels of random noise (e.g., macroblocks of the intra-coded frame that are mainly comprised of random noise and random noise of high amplitude values) which may be used as a reference for subsequent macroblocks of inter-coded frames that also include high levels of random noise.

For blocks, which may include macroblocks or sub-macroblocks, of inter-coded frames that contain high levels of random noise, the mode decision block 220 may implement the noise optimized mode decision process. To avoid switching artifacts, the mode decision block 220 may progressively change the mode decision process from standard to the noise optimized process based on the value of the actvar parameter for each block. The noise optimized mode decision process may alter RD score algorithms for the various available modes to penalize the associated RD scores. By penalizing the RD scores instead of eliminating certain encoding modes, the mode decision block 220 may still select the “best” mode without unduly limiting the variety of available modes. The selected best mode may then be provided to one or more other components of the encoder 200 so that the block is efficiently encoded while preserving the original random noise.

Actvar may be used to classify the content of the block, such as the presence of random noise, and may be a ratio between overall pixel-to-pixel variation in a block and overall deviation from an average intensity. Further, ranges may be associated with actvar that may be used to classify the content. For example, low actvar values may correspond to an edge, while high values (18 and above for example) may correspond to random noise. For the random noise range, the higher the value, the purer the random noise within that block. The random noise shown by a block's actvar value may be used to progressively change the mode decision process from normal into a noise optimized mode to avoid any potential switching artifacts. Further detail regarding actvar may be found in co-pending application Ser. No. 13/937,733 entitled “APPARATUSES AND METHODS FOR ADJUSTING A QUANTIZATION PARAMETER TO IMPROVE SUBJECTIVE QUALITY”, filed Jul. 9, 2013, which is incorporated by reference herein for any purpose.

The RD score may be a description of the rate and distortion a particular mode may generate when encoding a block using that particular mode. The mode decision 220 may calculate the RD score for each available encoding mode. The RD scores may then be evaluated and the encoding mode with the lowest RD score selected for encoding that particular block. This process may be completed for each incoming block and may be completed for both intra-coding and inter-coding modes. The selected mode, the one associated with the lowest RD score, may then be communicated to the rest of the components of the encoder, the motion prediction 218 for example. Each available mode may have one or more algorithms that take into account various forms of the actvar, e.g., actvar for the block and actvar for a specific parameter of a mode, when calculating a modes RD score. In implementing the noise optimized mode decision process, the mode decision 220 may adjust the RD score calculation to account for an increase in random noise and further to penalize the available modes. By penalizing the RD score instead of striking a mode from use, the mode decision 220 may ensure all modes are evaluated and that the mode with the lowest RD score, e.g., the best mode, is chosen.

The transform 206 may perform a transform, such as a discrete cosine transform (DCT), on the residual to transform the residual to the frequency domain. As a result, an output of the transform 206 may be a block of coefficients that may, for instance, correspond to spectral components of data in the video signal. For example, the coefficient block may include a DC coefficient corresponding to a zero frequency component of the video signal. The DC coefficient may, for instance, represent an average value of the coefficient block. The coefficient block may further include one or more AC coefficients corresponding to higher (non-zero) frequency portions of the video signal.

The quantization block 208 may receive the block of coefficients and quantize the coefficients (e.g., DC coefficient and AC coefficients) to produce a quantized coefficient block. The quantization provided by the quantization block 208 may be lossy and/or may also utilize one or more quantization parameters, such as the adjusted quantization parameter QP′, to employ a particular degree of quantization for one or more coefficients of the coefficient block. A quantization parameter may correspond with an amount of spatial detail preserved during a respective quantization process. QP′ may be received from the mode decision block 220. The adjusted quantization parameter QP′ may be adjusted for each block, and/or may be based on information encoded by the encoder 200.

As noted above, the blocks and frames may be low pass filtered to preserve random noise. Low pass filtering the blocks may not negatively affect the quality of the random noise and may result in spending a reduced number or no coding bits on the high frequency components of the random noise. The low pass filtering may be implemented by the quantization block 208, which may receive a control signal to enable/disable the low pass filtering. Because the random noise may typically include a white spectrum, meaning the random noise likely includes components in a full spectrum of frequencies, directly encoding the random noise may use coding bits for all of those frequencies. This may cause less precision for each frequency due to the components, e.g., the coefficients, being highly quantized. The precision of the low frequency components of the random noise may be kept while filtering out the higher frequency components to preserve the quality of the random noise. Thus, low pass filtering the random noise may result in the reduction or elimination of the high frequency components leaving more coding bits available for encoding the low frequency components of the random noise. The quality of the random noise may then be preserved through encoding without requiring a high number of coding bits and bandwidth. Further, due to the variation in random noise in the video, the low pass filtering may be dynamically enabled/disabled in the presence of high levels of random noise that are desired to be preserved.

In some examples, the low pass filtering may be implemented by modifying forward quantization tables included in the quantization block 208. Conventionally, the forward quantization tables are an inverted version of the inverse quantization tables located at a decoder (not shown in FIG. 2) or in the inverse quantization block 210. The inverse quantization table may be specified by the compression format, or if supported, the inverse quantization table may be user specified. The quantization table may conventionally be a 2-dimensional table, with a typical size of 4×4 or 8×8 to match the DCT transform implemented in the transform 206. An increasing index in the table corresponds to a higher frequency coefficient/component. The quantization table and inverse quantization table may be defined as

QTfw[j][i]=1/QTinv[j][i] (Eq. 1),

and when the forward quantization table is generated as given by Equation 1, then all non-zero coefficients (e.g., the coefficients associated with each array index) may be constructed by a decoder into the original value, within the precision determined by the quantization process.

A conventional forward quantization process may be defined as:

Q coeff[j][i]=(coeff[j][i]*QTfw[j][i])/quant (Eq. 2),

where Qcoeff are quantized coefficients, coeff are full precision coefficients, typically produced by the DCT transform of the residual performed in the transform 206, QTfw is a forward quantization table, and quant is a value derived from QP′. Since the forward quantization table may not be normative, it may be dynamically modified based on the random noise content of the input. To low pass the random noise for instance, values in the table corresponding to higher frequency coefficients may be reduced. The reduction in the high frequency coefficients may reduce the value of the corresponding coefficients. The original unmodified inverse quantization table may not multiply the quantized coefficients as greatly, effectively behaving as a low pass filter.

The modified forward quantization table may then be modified as follows:

QTfwAlt[j][i]=QTfw[j][i]*(1*(8-scale)+scaleTable[j][i]*scale+4)/8 (Eq. 3),

where scale determines the amount of modification the quant table undergoes. This may allow a gradual transition from no low-passing (scale=0) for areas of no noise to a strong filtering (scale=8). It may be driven by actvar for instance on block or macroblock level. Scale may be determined as min(8, max(0, actvar−18)) where actvar values above 18 may indicate the block or macroblock is mainly comprised of random noise and the higher the value, which may be a maximum of 26, the greater the block includes the random noise. In some examples, the low pass filtering may additionally be implemented separately for luminance and chrominance values of the blocks.

The entropy encoder 222 may encode the quantized coefficient block to provide a coded bitstream. The entropy encoder 222 may be any entropy encoder known by those having ordinary skill in the art or hereafter developed, such as a variable length coding (VLC) encoder or a context-adaptive binary arithmetic coding (CABAC) encoder. The quantized coefficient block may also be inverse-quantized by the inverse quantization block 210. The inverse-quantized coefficients may be inverse transformed by the inverse transform block 212 to produce a reconstructed residual. The reconstructed video may be provided to the picture buffer 216 for use in future frames, and further may be provided from the picture buffer 216 to the mode decision block 220 for further mode decision processes.

In operation, the mode decision block 220 may receive a block (of a non-reference frame), a quantization parameter, a reference frame, and various statistics of the block. The various statistics may include a variance, an activity, and an activity-variance ratio, which may be referred to as actvar. The level of random noise in each block as indicated by actvar may subsequently be used to adjust the mode decision process performed by the mode decision block 220 from a standard process to the noise optimized process. In some embodiments, an actvar indicating a high level of random noise may be used to progressively increase an RD score of a plurality of available encoding modes based on the level of random noise in the block. Additionally, the actvar parameter may be used to periodically assess the noise levels of the input video to determine when to update an intra-coded frame to include higher levels of random noise for subsequently copying into inter-coded frames.

The encoder 200 may operate in accordance with one or more video coding standards, such as H.264. In examples employing coding standards, such as H.264, which employ motion prediction and/or compensation, the encoder 200 may further include a feedback loop having an inverse quantization block 210, an inverse transform 212, a reconstruction adder 214, and a picture buffer 216. These elements may mirror elements included in a decoder (not shown) that reverse, at least in part, the encoding process performed by the encoder 200. Additionally, the feedback loop of the encoder may include a prediction block 218 and the picture buffer 216.

In an example operation of the encoder 200, as depicted in FIG. 2, a video signal (e.g. a base band video signal) may be provided to the encoder 200. The video signal may be provided to the mode decision block 220. The mode decision block 220 may receive an actvar parameter, for instance from a pre-processor, and may determine an amount of noise in the video signal and whether to implement a standard mode decision or a noise optimized noise decision. An interceding mode determined by the mode decision block 220 based on a high actvar may then be provided to the other components of the encoder 200, along with various other parameters used by the encoder. The subtractor 204 may receive the video signal and may subtract a motion prediction signal from the video signal to generate a residual signal. The prediction signal may include random noise from a reference frame to preserve the random noise present in the input video. The residual signal may be provided to the transform 206 and processed using a forward transform, such as a DCT. As described, the transform 206 may generate a coefficient block that may be provided to the quantization block 208, and the quantization block 208 may quantize and/or optimize the coefficient block. Quantization of the coefficient block may be based on the quantization parameter QP′, and quantized coefficients may be provided to the entropy encoder 222 and thereby encoded into a coded bitstream.

Optionally, the quantization block 208 may implement a low pass filter on the residual to allow the random noise to pass while limiting or eliminating high frequency components of the random noise. Limiting the high frequency components may reduce the number of bits used by the encoder for encoding the input video. The low pass filtering may be performed in conjunction with or in place of the noise optimized mode decision process.

The quantized coefficient block may further be provided to the feedback loop of the encoder 200. That is, the quantized coefficient block may be inverse quantized and inverse transformed by the inverse quantization block 210 and the inverse transform 212, respectively, to produce a reconstructed residual. The reconstructed residual may be added to the predictor at the adder 214 to produce reconstructed video, which may be written to the picture buffer 216 for use in future frames, and fed back to the mode decision block 220 and the motion prediction block 218. Based, at least in part, on the reconstructed video signals, the motion prediction block 218 may provide a motion prediction signal to the adder 204.

Accordingly, the encoder 200 of FIG. 2 may provide a coded bitstream based on a video signal, where the coded bitstream is generated in part using adjusted mode decisions provided in accordance with embodiments of the present invention. The encoder 200 may be operated in semiconductor technology, and may be implemented in hardware, software, or combinations thereof. In some examples, the encoder 200 may be implemented in hardware with the exception of the mode decision block 220 that may be implemented in software. In other examples, other blocks may also be implemented in software.

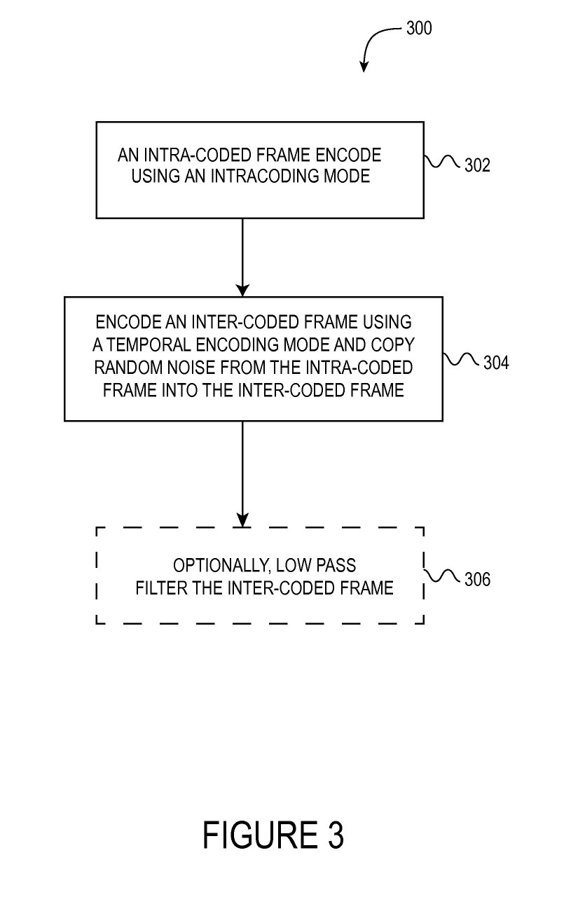

FIG. 3 is a flowchart 300 of a method for copying random noise into an encoded frame according to an embodiment of the present invention. The flowchart 300 illustrates the operation of encoder 100 and 200 implementing some aspects of the presently described efficient random noise encoding and the optional low pass filtering of an input. As discussed above, encoders, such as the encoder 100 and 200, may periodically encode an intra-coded frame, which may be used as a reference frame. The intra-coded frame may be used by the encoder in the encoding process for providing the residual. As such, the intra-coded frame is used in conjunction with various controls provided by the mode decision block to generate a predictor. The predictor may then be subtracted from input frames to provide a residual, which may then be encoded into a bitstream. The encoding of the intra-coded frame, however, may be performed differently than an inter-coded frame.

The method 300 may begin at step 302 with encoding an intra-coded frame using an intra-coding mode. For example, the intra-coded frame may include high levels of random noise in parts of the frame or throughout. Additionally, the intra-coded frame may be encoded on a block or macroblock level and each block may have differing amounts of random noise. The different amounts of random noise, as indicated by actvar, may affect the intra-coding mode selected. A mode decision block, such as the mode decision block 230, may evaluate all possible intra-coding modes available and may select the mode that uses the lowest number of bits, while still encoding the included random noise so that it is provided at a high level of visual quality, e.g., the properties of the random noise are not reduced or eliminated. The encoded intra-coded frame may then be buffered by the encoder and used as a reference frame.

The method 300 may continue at step 304 with copying the noise from the encoded reference frame into an inter-coded frame during encoding using motion estimation, where the inter-coded frame (e.g., a p-type or b-type frame). Again, the inter-coded frame may be encoded at the macroblock level. The mode decision block may know that the incoming frame/macroblocks are inter-coded frames and my limit the available modes to inter-coding modes so the predictive aspects of the encoder are implemented. The mode decision block may copy random noise from the reference frame (intra or inter coded frame) into a predictor. The mode decision block may select a macroblock from the reference frame that includes noise similar to the noise in the macroblock of the current frame to preserve the noise in the macroblock of the current frame. The copying of the noise from the reference frame is possible since encoded noise may not have to be a perfect representation of the original noise (e.g., the random noise in the macroblock of the current frame). Thus, as long as the encoded noise in the current frame maintains the properties of the original noise and it looks “like” the original noise, then the original noise may not need to be directly encoded. As such, the intercoding may take the random noise from the buffered reference frame instead of encoding the random noise included in the current frame.

The method 300 may optionally continue at step 306 with low pass filtering the encoded frames. The optional low pass filtering may be implemented for both the intra and inter-coded frames and may allow more coding bits to be spent on low frequency components of the random noise by reducing or eliminating the higher frequency components.

Accordingly, the method 300 may be used to implement one or more noise optimized mode decision processes to preserve random noise contained in input video and may be implemented at a frame or macroblock level. The noise optimized mode may preserve random noise in an inter-coded frame/macroblock by copying random noise from a reference frame into the current frame without directly encoding the random noise present in the original frame. Additionally, the random noise present in both intra and inter-coded frames may be low pass filtered so that a higher number of coding bits are available for low frequency components of the random noise to better preserve the random noise during encoding processes.

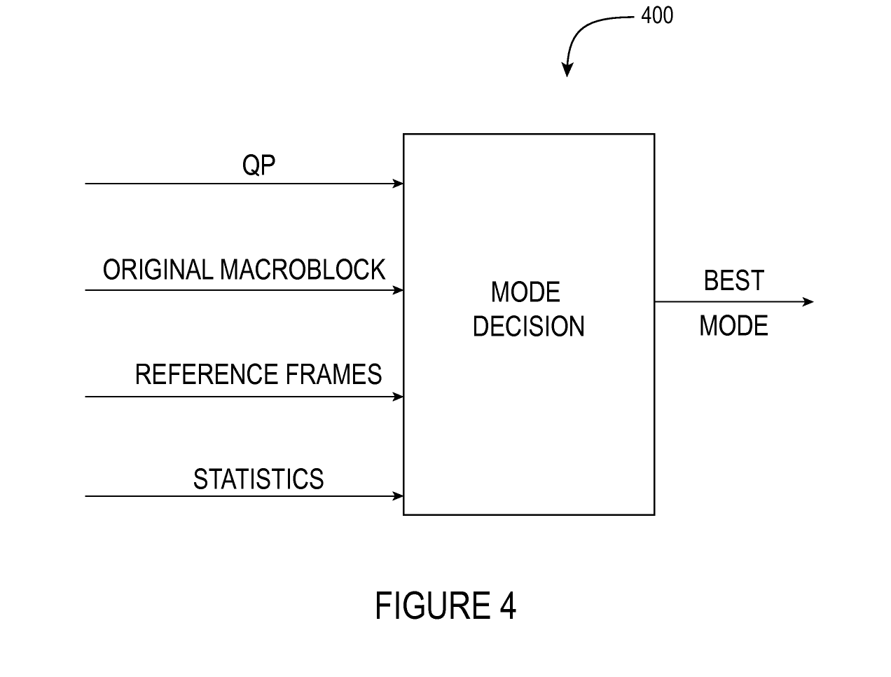

FIG. 4 is a block diagram of a mode decision block 400 according to an embodiment of the present disclosure. The mode decision block 400 may be used in the example encoder 100 or as the example mode decision block 220 of the encoder 200. The mode decision block 400 may be used to determine the best mode for encoding frames of input video. The frames may be encoded on the block or macroblock level with each frame comprising a plurality of blocks or macroblocks. The mode decision block 400 may also receive as inputs a quantization parameter (QP), the pixels of the macroblock to be encoded, a reference frame, and statistics derived from the input macroblock. The mode decision block 400 may use the various inputs to determine a best mode for encoding the current macroblock. The mode decision block 400, however, may implement the noise optimized mode decision process for frames and/or macroblocks that include high levels of random noise. To this end, the mode decision block 400 may modify algorithms used to calculate the RD score for various encoding tools in the presence of random noise. The objective may be to efficiently encode the random noise using the fewest bits as possible while preserving the random noise.

The mode decision module 400 may use the statistics and modified algorithms to determine the best mode to use for encoding the macroblocks of inter-coded frames, such as p-frames and b-frames. The various tools to efficiently encode random noise using inter-coding or intra-coding may have a respective RD score calculated using the various inputs. The respective RD scores may be penalized based on the level of random noise in the macroblocks of the inter-coded frames. An advantage of macroblock level detection may allow the mode decision to be adaptively changed based on local content.

The statistics provided to the mode decision block 400 may represent various factors of the macroblock to be encoded and may be calculated by a pre-processor (not shown), for example, or may be calculated by the mode decision block 400. The statistics may include the actvar parameter. Actvar may be used to classify the content of the macroblock, such as the presence of random noise, and may be a ratio between overall pixel-to-pixel variation in a macroblock and overall deviation from an average intensity. Further, ranges may be associated with actvar that may be used to classify the content. For example, low actvar values may correspond to an edge, while high values (18 and above for example) may correspond to random noise. For the random noise range, the higher the value, the purer the random noise within that macroblock. Purer random noise may refer to the amount of random noise covering the macroblock and/or the amplitude level of the random noise. The random noise shown by a macroblock's actvar value may be used to progressively change the mode decision process from normal into a noise optimized mode to avoid any potential switching artifacts.

The statistics along with various algorithms corresponding to different intra- and inter-coding modes may be used by the mode decision block 400 to calculate corresponding RD scores. The following is a description of the algorithms, in pseudocode format, for adjusting the RD score for each of a plurality of encoding modes. The pseudocodes listed may be seen as adjusted so that their associated mode is biased against by the mode decision block 400. The list is not exhaustive and is presented for illustration only. One skilled in the art would understand how to implement the noise optimized mode decision process on other modes based on the present disclosure. As such, the following list and discussion is not limiting on the present disclosure.

One mode may include lowering the QP if the QP was increased too high due to the random noise. An encoder may increase QP due to high spatial complexity of the random noise included in a frame. The QP may be an expected quality desired to be preserved in the encoded video. Encoding with a high QP may eliminate the random noise all together. In an encoder with the random noise optimized mode decision, the QP may be lowered since inter-coded frames will preserve the noise using a smaller number of bits. The lower QP may result in the noise being preserved better in the intra-coded frames without over spending in the inter-coded frames, e.g., using a large number of bits to encode the inter-coded frames.

Inter-coding modes that use bi-directional prediction on macroblocks and partitions may be biased against to preserve the random noise. Bi-directional prediction may combine two reference frames with motion compensation to generate a predictor for a current macroblock. However, combing two reference frames in this situation may average the random noise in the predicted macroblock, which may reduce the amplitude. A reduction in amplitude, however, may negatively impact the visual quality of the random noise. The pseudo code for this modification is as follows and the bid score value is the RD score for bi-directional macroblock type or a bi-directional partition type:

if (actvar>18)

bidir_score=(bidir_score*(actvar−10)+4)/8.

In the previous, the value of bidir_score may increase when actvar begins to increase above 18. Thus, as actvar increases above 18, the RD score for this mode increases, making it less attractive to the mode decision block 400. The integer values shown are only for example and may be used for rounding purposes.

Inter-coding modes that generate a predictor that does not contain any random noise may be biased against by the mode decision block 400. The motion estimation, such as the motion prediction 220 of FIG. 2, may look at the current macroblock and the reference frame then attempt to find the best match between the macroblock and the reference. The motion estimation, however, may find a macroblock of the reference frame that does not contain any random noise, which would not preserve the random noise if used as the predictor. Thus, to preserve the random noise, the mode decision block 400 may exclude candidate areas that do not include similar random noise and include the areas that do. The pseudo code for this mode is:

```
if (mb_is_inter && actvar>21 && activity>1000 &&
noise_macroblocks<90)
{
    Actvar_pred = GetActVarOfPredictor( );
    if (actvar_pred<18)
    {
        if (frame_is_not_btype)
            score = score*2;
        else
            score = score*1.5;
    }
}
```

where mb_is_inter indicates that the current macroblock is inter-predicted, activity is the current macroblock activity as defined above, noise_macroblocks indicates the percentage of macroblocks within the frame having noise, frame_is_not_Btype indicates if the current frame is not a bi-predicted type and score is an RD score of the current macroblock type. Again, the values used are for illustration only. For inter-predicted macroblocks meeting the above conditions, actvar of the predictor is calculated and if it is below 18, then the tested macroblock type is biased against by increasing its score. The pseudo code illustrates that for macroblocks for which the predictor does not include random noise, the RD score should be penalized by increasing the RD score value.

Inter-coding modes that reconstruct the random noise with a different amplitude may also be biased against. This may be implemented by the mode decision block 400 by determining when a predictor reconstructs the random noise with higher or lower amplitude than the original random noise. For example a DistortionLuma value may be calculated, which measures the difference between the original and the reproduced image in terms of luminance. A similar calculation may be performed for chrominance (e.g., blue chrominance, red chrominance). Their convolution may provide the RD score for this mode. The pseudo code is:

```
if (actvar>18)
{
    varO = L2NormVariance (Orignal_pixels);
    varR = L2NormVariance (Reconstructed_pixels);
    DistortionLuma+ = (min(8, actvar−18)*scale*abs(varO−varR))/16;
}
```

where DistortionLuma is a sum of squared pixel differences between the original and reconstructed macroblock luminance pixels. The reconstructed pixels may have been processed by in-loop deblocking as well. DistortionLuma is increased proportionally to the difference between the original and reconstructed macroblock variance. DistortionLuma and DistorionChroma may be used by the mode decision block 400 to calculate the RD score for this mode using standard techniques.

The mode decision block 400 may bias against intra macroblocks if the reconstructed pixels do not preserve the random noise. The pseudo code for the adjusted RD score algorithm is:

```
if (mb_is_intra && actvar>21 && noise_macroblocks<90)
{
    actvarRecon = GetActVarOfRecon( );
    if (actvarRecon<18)
    {
        if (frame_is_not_Btype)
            score = score*2;
        else
            score = score*1.5;
    }
}
```

where mb_is_intra indicates that the current macroblock is intra-predicted, noise_macroblocks indicates the percentage of macroblocks within the frame having noise, frame_is_not_Btype indicates if the current frame is not a bi-predicted type and score is an RD score of the current macroblock type. For intra-predicted macroblocks meeting the above conditions, actvar of the reconstructed pixels is calculated and if it is below 18, then the tested macroblock type is biased against. The reconstructed pixels might have been processed by in-loop deblocking as well.

The mode decision block 400 may lower dQP limit for macroblocks containing noise, where the dQP limit is the minimum amount QP is allowed to change between macroblocks. A big difference between QP between macroblocks may be noticeable in the reconstructed frame and may negatively impact the visual quality of the video. The pseudo code is:

if (actvar>20)
min_dQP = min_dQP/2;

where mindQP is the minimum difference in QPs in between consecutive macroblocks. An encoder might be using such a limit to reduce the QP signaling overhead. Visual quality of random noise is typically very sensitive to the QP, thus lowering the delta QP limit allows the encoder to encode the areas with random noise more consistently.

The mode decision block 400 may bias against intra macroblocks in inter frames. The pseudo code is:

if (actvar>18)
intra_cost = (intra_cost*(2*(actvar−18)+24)+12)/24;

where intra_cost is the RD score of the intra macroblock type. Intra macroblocks are in general expensive to code. In inter-coded frames containing random noise, inter-coded macroblocks are much cheaper thus they should be getting selected. Increasing the RD score of the intra macroblocks will make the mode decision to less likely to select intra macroblocks.

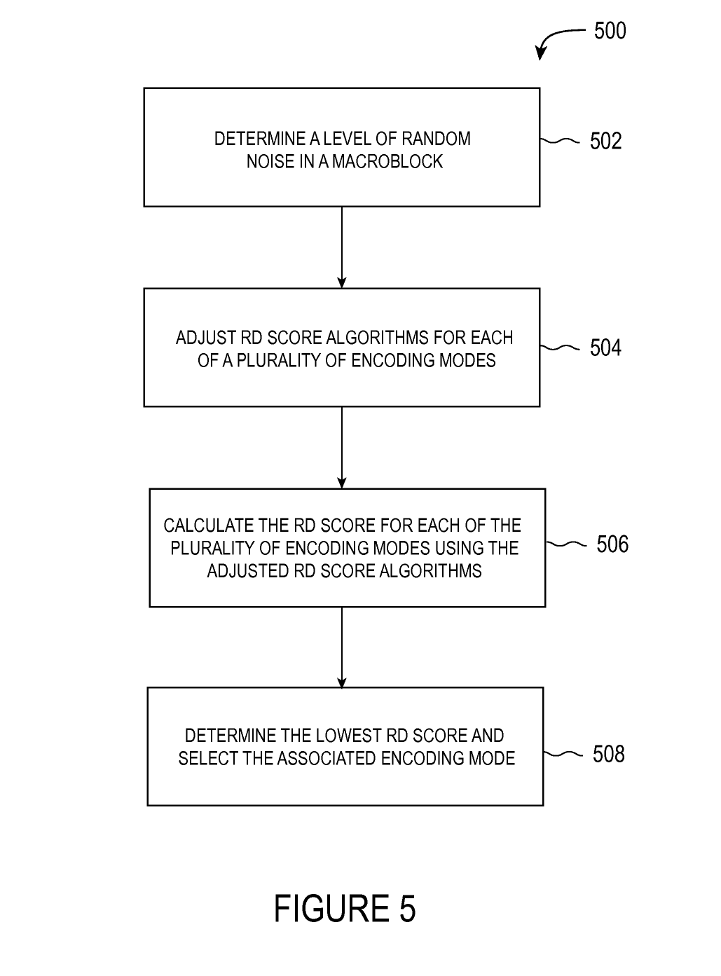

The noise optimized mode decision process of the mode decision block 400 will be more fully described in conjunction with FIG. 5. FIG. 5 is a flowchart of a method 500 for adjusting a mode decision process for efficiently encoding random noise according to an embodiment of the present invention. The method 500 may be implemented by the mode decision block 230 of FIG. 2 or by the encoder 100 of FIG. 1.

Periodically, an encoder, such as the encoder 100 and 200, may encode an intra-coded frame to use as a reference for encoding subsequent frames and macroblocks using inter-coding modes. The intra-coded frame, however, may be encoded using an intra-coding mode. The intra-coded frame may be generated periodically to assist with the decoding of video streams, for example. The intra-coded frame may include areas of high levels of random noise, which may be costly and difficult to encode using predictive coding modes. Thus, the mode decision block 400 may evaluate a plurality of intra-coding modes to determine the intra-coding mode that is the least costly in terms of bits but still provides random noise of high visual quality. The reference frame may then be encoded with using the selected intra-coding mode and stored in a buffer, the picture buffer 218 of FIG. 2 for example. The intra-coded frame may then be used for implementing temporarily predictive encoding modes, inter-coding, for subsequent frames.

The method 500 may begin at step 502 with determining a level of random noise in a macroblock. This may be performed by evaluating the actvar associated with the macroblock. An actvar level greater than 18, for example, may indicate the macroblock is mostly comprised of random noise and the closer actvar is to 26, the purer the random noise. The determination of the level of random noise may cause a mode decision block to switch from a standard mode decision process to a noise optimized mode decision process. As such, as actvar rises above the level of 18, the noise optimized mode decision may be implemented.

The method 500 may then continue at step 504 with adjusting an RD score algorithm for each of a plurality of encoding modes. A mode decision block, such as the mode decision block 400, may use the noise optimized RD score algorithms for the various modes as discussed above. The adjusted RD score algorithms may be implemented to penalize the RD scores for each the plurality of encoding modes due to the random noise. The modes are penalized when the random noise is not preserved.

The method 500 may then continue at step 506 with calculating the RD score for each of the plurality of encoding modes based on the adjusted RD score algorithms. The method may then end at step 508 with determining the lowest RD score and selecting the encoding mode associated with that lowest RD score. An encoder implementing the method 500 may then efficiently encode random noise contained in the inter-coded frames of an input video.

Encoders described herein may operate in accordance with one or more coding methodologies, and during operation, random noise in reference frames may be copied into sub-sequent inter-coded frames in order to efficiently encode and preserve the original random noise contained in the original frames. For example, encoders may adjust RD score calculations performed by a mode decision block to select a best mode to preserve the original noise. The selected best mode may then be implemented by an encoder to efficiently encode the noise. Alternatively or additionally, the encoder may low pass filter the video to also preserve the random noise while reducing or eliminating the encoding bits used for the high frequency components of the random noise.

One or more of the methods and/or any pseudocode described herein may be implemented as computer executable instructions stored on computer readable media and/or executed on one or more processors or processor cores. Computer readable media may include any form of computer readable storage or computer readable memory, transitory or non-transitory, including but not limited to externally or internally attached hard disk drives, solid-state storage (such as NAND flash or NOR flash media), tiered storage solutions, storage area networks, network attached storage, and/or optical storage.

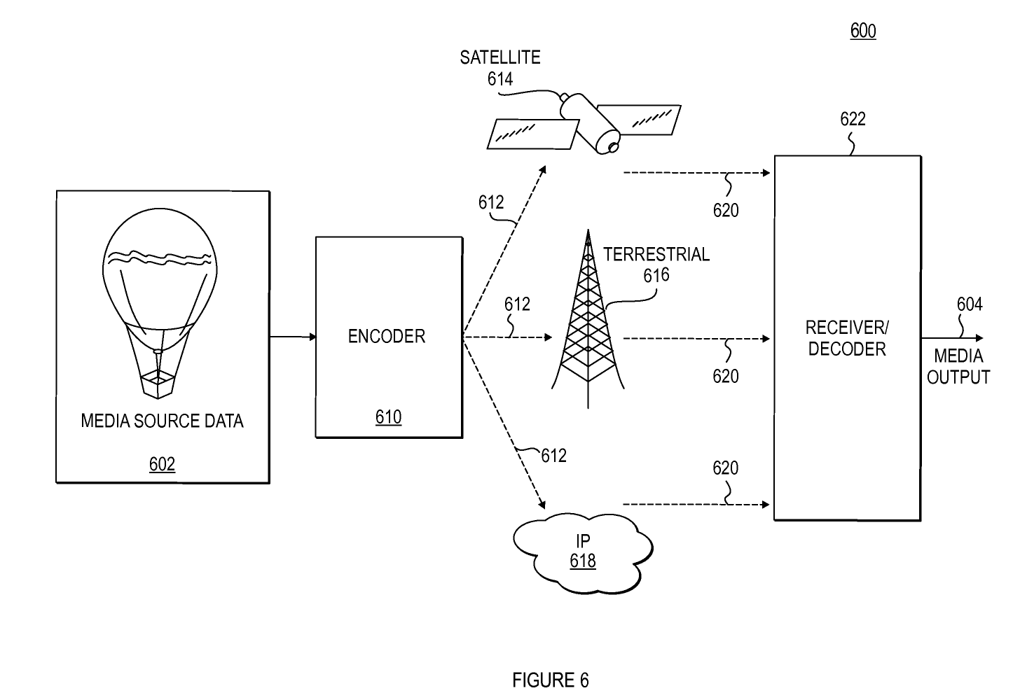

FIG. 6 is a schematic illustration of a media delivery system 600 in accordance with embodiments of the present invention. The media delivery system 600 may provide a mechanism for delivering a media source 602 to one or more of a variety of media output(s) 604. Although only one media source 602 and media output 604 are illustrated in FIG. 6, it is to be understood that any number may be used, and examples of the present invention may be used to broadcast and/or otherwise deliver media content to any number of media outputs.

The media source data 602 may be any source of media content, including but not limited to, video, audio, data, or combinations thereof. The media source data 602 may be, for example, audio and/or video data that may be captured using a camera, microphone, and/or other capturing devices, or may be generated or provided by a processing device. Media source data 602 may be analog or digital. When the media source data 602 is analog data, the media source data 602 may be converted to digital data using, for example, an analog-to-digital converter (ADC). Typically, to transmit the media source data 602, some type of compression and/or encryption may be desirable. Accordingly, an encoder 610 may be provided that may encode the media source data 602 using any encoding method in the art, known now or in the future, including encoding methods in accordance with video standards such as, but not limited to, MPEG-2, MPEG-4, H.264, H.HEVC, or combinations of these or other encoding standards. The encoder 610 may be implemented using any encoder described herein, including the encoder 100 of FIG. 1 and the encoder 200 of FIG. 2.

The encoded data 612 may be provided to a communications link, such as a satellite 614, an antenna 616, and/or a network 648. The network 648 may be wired or wireless, and further may communicate using electrical and/or optical transmission. The antenna 616 may be a terrestrial antenna, and may, for example, receive and transmit conventional AM and FM signals, satellite signals, or other signals known in the art. The communications link may broadcast the encoded data 612, and in some examples may alter the encoded data 612 and broadcast the altered encoded data 612 (e.g. by re-encoding, adding to, or subtracting from the encoded data 612). The encoded data 620 provided from the communications link may be received by a receiver 622 that may include or be coupled to a decoder. The decoder may decode the encoded data 620 to provide one or more media outputs, with the media output 604 shown in FIG. 6.

The receiver 622 may be included in or in communication with any number of devices, including but not limited to a modem, router, server, set-top box, laptop, desktop, computer, tablet, mobile phone, etc.

The media delivery system 600 of FIG. 6 and/or the encoder 610 may be utilized in a variety of segments of a content distribution industry.

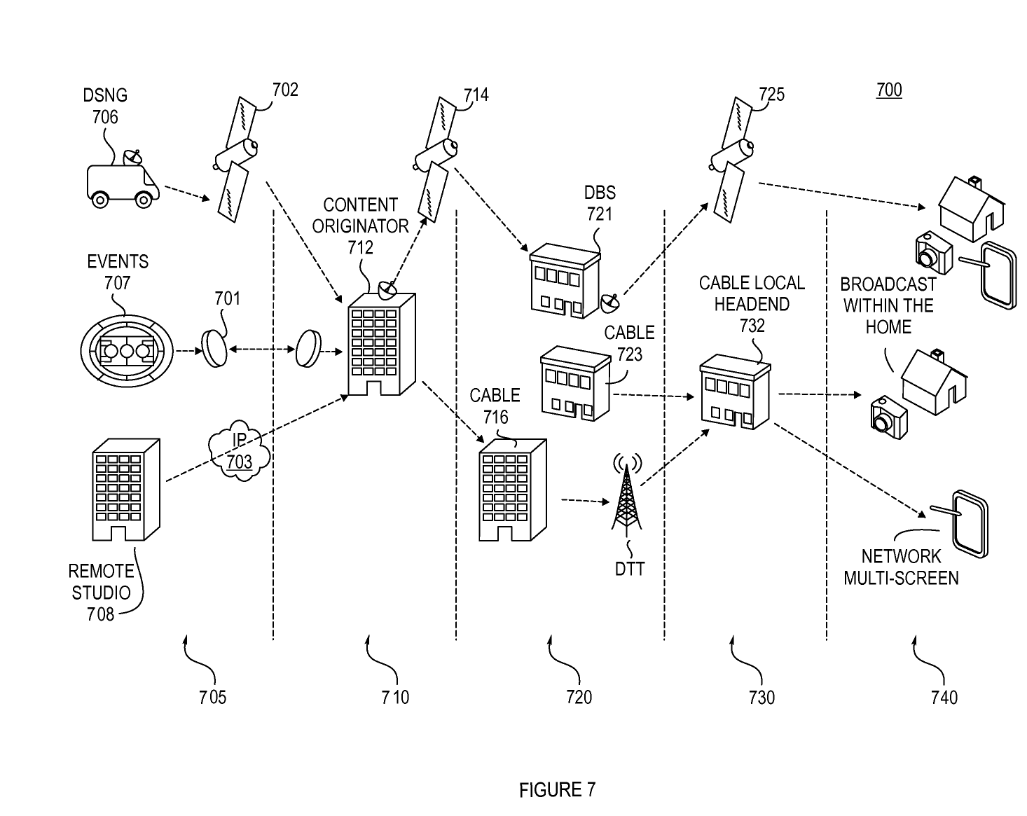

FIG. 7 is a schematic illustration of a video distribution system that 700 may make use of encoders described herein. The video distribution system 700 includes video contributors 705. The video contributors 705 may include, but are not limited to, digital satellite news gathering systems 706, event broadcasts 707, and remote studios 708. Each or any of these video contributors 705 may utilize an encoder described herein, such as the encoder 610 of FIG. 6, to encode media source data and provide encoded data to a communications link. The digital satellite news gathering system 706 may provide encoded data to a satellite 702. The event broadcast 707 may provide encoded data to an antenna 701. The remote studio 708 may provide encoded data over a network 703.

A production segment 710 may include a content originator 712. The content originator 712 may receive encoded data from any or combinations of the video contributors 705. The content originator 712 may make the received content available, and may edit, combine, and/or manipulate any of the received content to make the content available. The content originator 712 may utilize encoders described herein, such as the encoder 610 of FIG. 6, to provide encoded data to the satellite 714 (or another communications link). The content originator 712 may provide encoded data to a digital terrestrial television system 716 over a network or other communication link. In some examples, the content originator 712 may utilize a decoder to decode the content received from the contributor(s) 705. The content originator 712 may then re-encode data and provide the encoded data to the satellite 714. In other examples, the content originator 712 may not decode the received data, and may utilize a transcoder to change an encoding format of the received data.

A primary distribution segment 720 may include a digital broadcast system 721, the digital terrestrial television system 716, and/or a cable system 723. The digital broadcasting system 721 may include a receiver, such as the receiver 622 described with reference to FIG. 6, to receive encoded data from the satellite 714. The digital terrestrial television system 716 may include a receiver, such as the receiver 622 described with reference to FIG. 6, to receive encoded data from the content originator 712. The cable system 723 may host its own content which may or may not have been received from the production segment 710 and/or the contributor segment 705. For example, the cable system 723 may provide its own media source data 602 as that which was described with reference to FIG. 6.

The digital broadcast system 721 may include an encoder, such as the encoder 610 of FIG. 6, to provide encoded data to the satellite 725. The cable system 723 may include an encoder, such as the encoder 610 of FIG. 6, to provide encoded data over a network or other communications link to a cable local headend 732. A secondary distribution segment 730 may include, for example, the satellite 725 and/or the cable local headend 732.

The cable local headend 732 may include an encoder, such as the encoder 610 of FIG. 6, to provide encoded data to clients in a client segment 740 over a network or other communications link. The satellite 725 may broadcast signals to clients in the client segment 740. The client segment 740 may include any number of devices that may include receivers, such as the receiver 622 and associated decoder described with reference to FIG. 6, for decoding content, and ultimately, making content available to users. The client segment 740 may include devices such as set-top boxes, tablets, computers, servers, laptops, desktops, cell phones, etc.

Accordingly, encoding, transcoding, and/or decoding may be utilized at any of a number of points in a video distribution system. Embodiments of the present invention may find use within any, or in some examples all, of these segments.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method for efficiently encoding noise comprising:
intra-encoding, with an encoder, a frame that includes noise; and
copying, with the encoder, the noise from the intra-encoded frame into a subsequent frame during encoding using motion estimation.

2. The method of claim 1, further comprising;
receiving, with the encoder, the frame;
determining, with the encoder, a mode for intra-encoding the frame;
encoding, with the encoder, the frame using the determined mode for intra-encoding the frame; and
buffering, with the encoder, the intra-encoded frame.

3. The method of claim 1, further comprising:
receiving, with the encoder, the subsequent frame;
determining, with the encoder, a best mode for inter-encoding the subsequent frame, wherein the best mode is an inter-encoding mode selected from a plurality of inter-encoding modes; and
encoding, with the encoder, the subsequent frame using the determined best mode for inter-encoding.

4. The method of claim 3, wherein determining, with the encoder, a best mode for inter-encoding the subsequent frame, wherein the best mode is an inter-encoding mode selected from a plurality of inter-encoding modes displaying a least impact on the quality of the noise copied from the intra-encoded frame comprises:
calculating an RD score for each of the plurality of inter-encoding modes; and
selecting the inter-encoding mode associated with the lowest RD score.

5. The method of claim 4, wherein the RD score calculated for each of the plurality of interencoding modes is calculated based on a noise optimized RD score algorithm.

6. The method of claim 1, wherein further comprising:
calculating an activity-variance parameter for the inter-coded frame; and
copying the noise from the intra-encoded frame based at least in part on the activity-variance parameter.

7. The method of claim 1, wherein copying, with the encoder, the noise from the intra-encoded frame into a subsequent frame during encoding using motion estimation comprises copying the random noise from an area of the intra-encoded frame that includes noise that is similar to noise included in the subsequent frame.

8. The method of claim 1, further comprising filtering the inter-coded frame with a low pass filter configured to provide more coding bits to low frequency components of the inter-coded frame.

9. An apparatus for copying noise from a reference frame into a subsequent frame comprising:
an encoder configured to copy noise from an intra-coded frame into an inter-coded frame based on a best mode decision, wherein the inter-coded frame at least partially comprises noise; and
a mode decision block configured to determine the best mode for encoding the inter-coded frame.

10. The apparatus of claim 9, wherein the encoder is configured to encode the intra-coded frame using an spatial encoding mode.

11. The apparatus of claim 10, wherein the mode decision block is further configured to determine a best spatial encoding mode for encoding the intra-coded frame based at least in part on an activity-variance parameter of the intra-coded frame, wherein the best spatial encoding mode is configured to preserve the quality of the noise in the intra-coded frame.

12. The apparatus of claim 9, wherein the best mode for encoding the inter-coded frame includes a temporal encoding mode that uses a block of the intra-coded frame as a noise reference.

13. The apparatus of claim 9, wherein the mode decision block is configured to evaluate a plurality of temporal encoding modes to determine the best temporal encoding mode for encoding the inter-coded frame.

14. The apparatus of claim 13, wherein the mode decision block is further configured to determine a rate distortion score for each of the plurality of temporal encoding modes and select the best mode based on the encoding mode associated with the lowest rate distortion score.

15. The apparatus of claim 9, wherein the best mode for encoding the inter-coded frame is an encoding mode that is configured to copy noise from an area of the intra-coded frame that most similarly compares to noise in the inter-coded frame.

17. The apparatus of claim 9, further comprising a low pass filter configured to low pass filter the inter-coded frame, wherein frequency coefficients of the low pass filter are based at least in part on an activity-variance parameter of the current inter-coded frame.

18. A non-transitory, computer-readable storage medium comprising executable code that when executed by a processor causes the processor to:
intra-encode frame, wherein the intra-encoded frame includes random noise;
determine a best mode for encoding a subsequent frame based at least in part on an activity-variance parameter; and
provide the best mode to an encoder to encode the subsequent frame, wherein the encoder copies noise from the reference frame into the subsequent frame based at least in part on the best mode to preserve noise in the subsequent frame.

19. The non-transitory, computer-readable storage medium of claim 18, further comprising code that when executed by a processor causes the processor to:
low pass filter the subsequent frame prior to encoding, wherein coefficients of the low pass filter are based at least in part on an activity-variance parameter of the subsequent frame.

20. The non-transitory, computer-readable storage medium of claim 18, further comprising code that when executed by a processor causes the processor to:
calculate a rate distortion score for each of a plurality of encoding modes based on subsequent frame statistics including the activity-variance parameter;
determine the lowest calculated rate distortion score; and
select the encoding mode of the plurality of encoding modes associated with the lowest rate distortion score as the best mode.

21. The non-transitory, computer-readable storage medium of claim 18, wherein the intra-encoded frame is encoded using a spatial encoding mode.

22. The non-transitory, computer-readable storage medium of claim 18, wherein the best mode is a temporal encoding mode.
